(19) United States
(12) Patent Application Publication
(10) Pub. No.: US 2003/0176085 A1
(43) Pub. Date: Sep. 18, 2003

(54) ELECTRICAL CONNECTOR ASSEMBLY

(75) Inventor: Matthew Laker, Genola, UT (US)

Correspondence Address: Vaughn W. North, THORPE NORTH & WESTERN, L.L.P., P.O. Box 1219, Sandy, UT, 84091-1219, US

(73) Assignee: ATL TECHNOLOGY, LC.

(21) Appl. No.: 10/374,767

(22) Filed: Feb. 24, 2003

Related U.S. Application Data
(60) Provisional application No. 60/359,950, filed on Feb. 25, 2002.

(51) Int. Cl. H01R 12/00

(52) U.S. Cl. 439/76.1

(57) ABSTRACT

A method and apparatus for providing a cable connector configured for high frequency signal transmission. The cable connector includes a printed circuit board (“PCB”), at least one conductive cable and a shield structure. The PCB includes a first side with a plurality of conductive traces formed thereon, each trace having a first end and a second end, and a second side with a shield layer formed thereon. The at least one conductive cable includes a plurality of conductive wires with one end of each wire being electrically connected to the first end of one of the plurality of conductive traces. The shield structure is mounted over the first side of the PCB to provide shielding and is connected to a portion of the at least one conductive cable. The shield structure further includes grounding contacts that are coupled to a portion of the first side of the PCB and to the shield layer.

Priority is hereby claimed to U.S. Provisional patent application, serial no. 60/359,950 filed Feb. 25, 2002, in the U.S. Patent Office.

### BACKGROUND OF THE INVENTION

1. Field of the Invention

The present invention relates generally to electrical connectors and, more particularly, the present invention relates to an electrical connector assembly with improved performance characteristics and a simplified method of manufacture.

2. State of the Art

In high frequency connector applications, such as data connectors, the trend in the industry is to increase the density of electrical connections while reducing the overall cost of the connector. Increasing the density is achieved by reducing the size of the connectors, along with the housings and contacts therein. Such reduction in density can directly affect the electrical transmission characteristics and structural integrity of the connector.

High frequency connector applications typically involve shielding the connector structure with a conductive member. The conductive member, or shielding member, is then interconnected to the conductive shielding of the high frequency cable. Such a conductive member is utilized to provide shielding to prevent interference between the connector environment and the electrical signals therein. As such, for optimal performance in most systems, the characteristic impedance of the signal path through the connector structure is exactly that of the rest of the transmission path. This enables the connector structure to be essentially invisible to the electrical signals, thereby providing the best possible data transmission capability for the particular connector/cable combination.

In many applications, especially the data communications industry, the connectors used to form electrical interconnections must be shielded to prevent various electrical signals and noise from affecting the signals in the network. It is known in the art to provide conductive shielding around an electrical connector to prevent inverse interference in the exterior of the connector from affecting the signals being conducted within the connector. Typically, the conductive shielding is formed as a metal shell that surrounds the terminal block of the electrical connector.

The manufacture of high frequency connectors, namely, data connectors involves numerous process steps that each increases the cost and the complexity of the data connector. For example, the introduction of the shielding member requires various manufacturing steps to provide the proper shielding characteristics. Further, in mass production, the material required in manufacturing the shielding member is costly.

Accordingly, what is needed is an improved device that includes a shielding structure that improves performance in operation, that reduces manufacturing steps in implementation, and that provides a cost advantage over that of the prior art by simplifying the manufacturing process.

### SUMMARY OF THE INVENTION

The present invention relates to a method and apparatus for providing a cable connector configured for high frequency signal transmission. The cable connector includes a printed circuit board (“PCB”), at least one conductive cable and a shield structure. The PCB includes a first side with a plurality of conductive traces formed thereon, each trace having a first end and a second end, and a second side with a shield layer formed thereon. The at least one conductive cable includes a plurality of conductive wires with one end of each wire being electrically connected to the first end of one of the plurality of conductive traces. The shield structure is mounted over the first side of the PCB to provide shielding and is connected to a portion of the at least one conductive cable. The shield structure further includes grounding contacts that are coupled to a portion of the first side of the PCB and to the shield layer.

In another embodiment, the cable connector includes a PCB, at least one conductive cable, a plurality of terminal contacts, a dielectric core and a shield structure. The PCB includes a first side with a plurality of conductive traces formed thereon, each trace having a first end and a second end, and a second side with a shield layer formed thereon. The at least one conductive cable includes a plurality of conductive wires with one end of each wire being electrically connected to the first end of one of the plurality of conductive traces. The plurality of terminal contacts each includes a portion coupled to the second end of one of the plurality of conductive traces. The dielectric core includes notches defined therein and is operable to be disposed over the first side of the PCB with the plurality of terminal contacts and the ends of the plurality of conductive wires disposed in the notches defined in the dielectric core. The shield structure includes a substantially planar surface with end portions extending laterally from opposing ends of the planar surface. The shield structure is operable to be disposed over the dielectric core with the end portions wrapped around to couple with a peripheral side portion of the shield layer. With this arrangement, the shield structure and the shield layer act in conjunction to provide a shielding package for the cable connector.

Other features and advantages of the present invention will become apparent to those of ordinary skill in the art through consideration of the ensuing description, the accompanying drawings, and the appended claims.

### BRIEF DESCRIPTION OF THE DRAWINGS

While the specification concludes with the claims particularly pointing out and distinctly claiming that which is regarded as the present invention, the advantages of this invention may be ascertained from the following description of the invention when read in conjunction with the accompanying drawings, in which:

FIG. 1 illustrates a perspective view of an exposed high frequency connector, depicting a front side of a printed circuit board with cables and terminals coupled thereto;

FIG. 1(a) illustrates a perspective view of a back side of the printed circuit board having a shield layer formed thereon;

FIG. 2 illustrates a perspective view of the connector depicted in FIG. 1 with an additional dielectric core coupled to the front side of the printed circuit board;

FIG. 2(a) illustrates a perspective view of an inner side of the dielectric core, depicting separator elements formed on the inner side of the dielectric core;

FIG. 3 illustrates a perspective view of the connector depicted in FIG. 2 with an additional shielding structure wrapped around the dielectric member;

FIG. 3(a) illustrates a cross-sectional view of the connector taken along line A-A in FIG. 3, depicting the shielding structure wrapped around the dielectric member and coupled to a peripheral portion of the shield layer on the back side of the printed circuit board;

FIG. 4 illustrates a perspective view of the connector depicted in FIG. 3 with a housing unit configured to be disposed around the shielding structure on the connector;

FIG. 5 illustrates a perspective view of the connector depicted in FIG. 4 with an over-mold structure formed around a portion of the cables to provide enhanced protection to the cable connections to the connector;

FIG. 6 illustrates, in flow chart form, an embodiment by which the high frequency connector can be manufactured and assembled; and

FIG. 7 illustrates an exploded view of the components of the high frequency connector depicted in FIG. 5.

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art having possession of this disclosure, are to be considered within the scope of the invention.

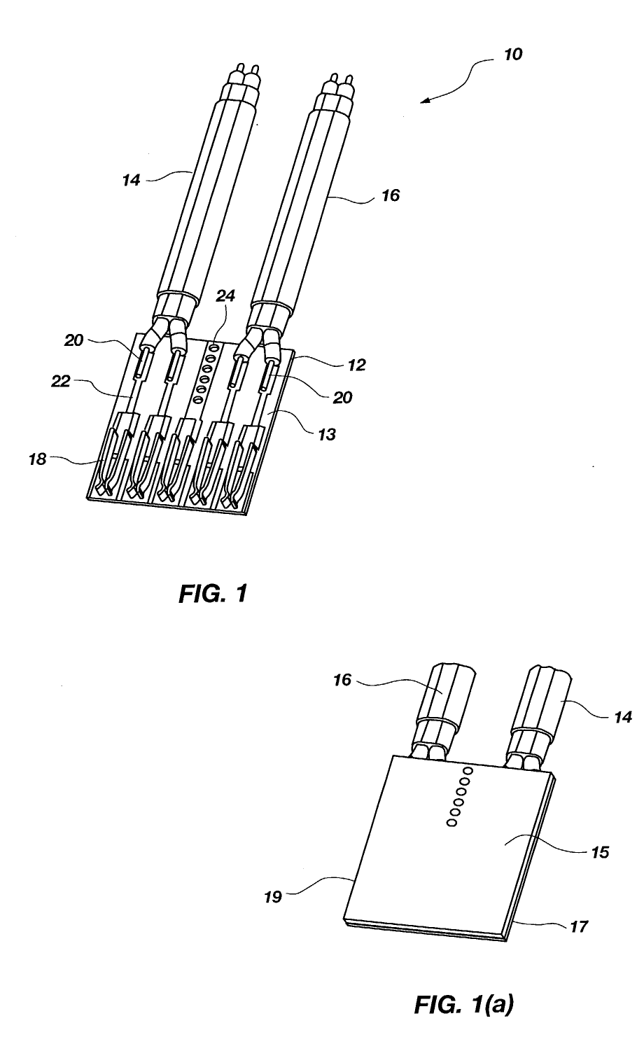

Turning first to FIGS. 1 and 1(a), the electrical connector 10, illustrated in exposed form, includes a printed circuit board 12 (“PCB”). The PCB 12 is an integral component in the electrical connector 10 for facilitating high frequency data transmission. The PCB 12 is formed generally rectangular in shape and includes a front side 13 and a back side 15. The front side 13 of the PCB 12 includes conductive traces 22 thereon, which are formed and spaced to extend over a portion of the front side 13 of the PCB 12 in a predetermined pattern. The conductive traces 22 are typically formed from copper or an alloy thereof with nickel and/or gold plating thereon, but can be formed from other suitable electrically conductive materials known in the art. The back side 15 of the PCB 12 includes a shield layer 19 formed thereon and can be formed to extend over substantially the entire surface of the back side 15 of the PCB 12. Such a shield layer 19 is an electrically conductive material, such as copper or an alloy thereof with nickel and/or gold plating formed thereon, but can be any suitable electrically conductive material known in the art.

The PCB 12 is manufactured so as to provide an increase in electrical performance, i.e., impedance matching, in the electrical connector 10. By utilizing a PCB 12 within the electrical connector 10, such electrical performance and characteristics can be manipulated and controlled. For example, the electrical characteristics can be controlled by carefully selecting: (1) the geometry of the traces; (2) the spacing between the traces; (3) the spacing between a single trace and other electrically conductive components in the connector; and, (4) the spacing between a single trace and a differential mate of the single trace. Much “high speed” signaling is performed differentially. In other words, the voltage in one conductor at any given time is the opposite of the voltage in the mate of such conductor. Utilizing the PCB 12 to manipulate the electrical characteristics therein provides signaling that is much more robust than a single transmission line. The electrical connector 10 of the present invention is to be used in both differential and non-differential signaling situations. Accordingly, the PCB 12 can be optimized for characteristic impedance by altering the dielectric constant of the material utilized in manufacturing the PCB 12 as well as by carefully designing the size of path and the size of traces fabricated on the PCB 12. Such a PCB 12 can be formed and implemented, with optimal electrical performance and characteristics with respect to the additional components of the electrical connector 10 described herein, by one of ordinary skill in the art.

For example, the characteristic impedance of a path on a PCB 12, when considered independent of other properties and constants, can be approximately doubled by reducing the width of the trace by one half. This careful design of the PCB 12 further enables the designer to optimize the cable assembly for maximum signal carrying capability. Further, the ability to modify PCB 12 during subsequent manufacturing processes allows for quick and inexpensive impedance optimization to be achieved as well as to provide balancing through either passive or buried resistances, etc. The contact is located on four mm centers and two “combs” (not shown) are placed on the PCB 12 for assembly. A comb is a carrier strip carrying contacts as produced by the stamping die.

With the PCB 12 formed with predetermined geometries configured to have particular electrical characteristics, the PCB 12 can be coupled to a first and second cable 14 and 16 and a plurality of conductive terminals 18. The first and second cable 14 and 16 each include one or more exposed wire ends 20. Such wire ends 20 each can be positioned and bonded to one end of the traces 22. At the other end of the PCB 12, the conductive terminals 18 can be positioned and bonded to the traces 22. In this manner, a continuous electrical current path or signal path extends along each of the wire ends 20, the traces 22 and the conductive terminals 18.

The wire ends 20 and the conductive terminals 18 can be bonded to the traces 20 on the PCB 12 by any suitable method known to one of ordinary skill in the art, such as, soldering, ultrasonic or resistive welding, or electrical epoxy treatments. What is desired is that the connection be made quickly and efficiently, with a low failure rate, high output rate and good electrical contact.

The PCB 12 also includes a center trace contact 24, which can provide a blank electrical connection for various applications. In one embodiment, the center trace contact 24 can be used as a grounding contact. In another embodiment, the center trace contact 24 can be used as a signal contact.

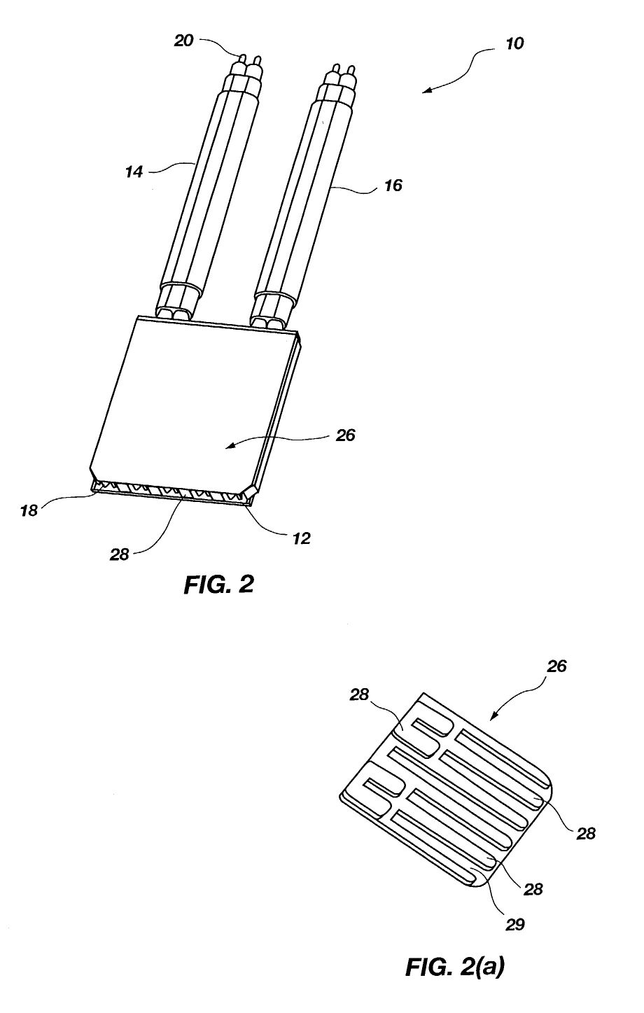

Turning now to FIGS. 2 and 2(a), once the conductive terminals 18 and first and second cables 14 and 16 are coupled to the PCB 12, a core 26 can be positioned over the front side of the PCB 12. The core 26 is configured to provide electrical insulation between the conductive components on the PCB 12, namely, the conductive terminals 18, the wire ends 20 and the grounding plane or shield structure (not shown). As such, the core 26 is a dielectric material and includes an outer side 27 and an inner side 29. The inner side 29 includes separator elements 28 which define notches in the core 26. The separator elements 28 can be configured to be formed to extend between and around the wire ends 20 and the conductive terminals 18 on the PCB 12. In this manner, the inner side 29 of the core 26 is positioned to face the PCB 12 with the terminals 18 and wire ends 20 disposed in the notches defined in the core with the outer side 27 facing away from the PCB 12. With the core 26 positioned over the PCB 12, the core 26 can serve as a stopper member during an over-mold process to be discussed hereinbelow. The core 26 can also serve as an overstress protection at the points of electrical contact.

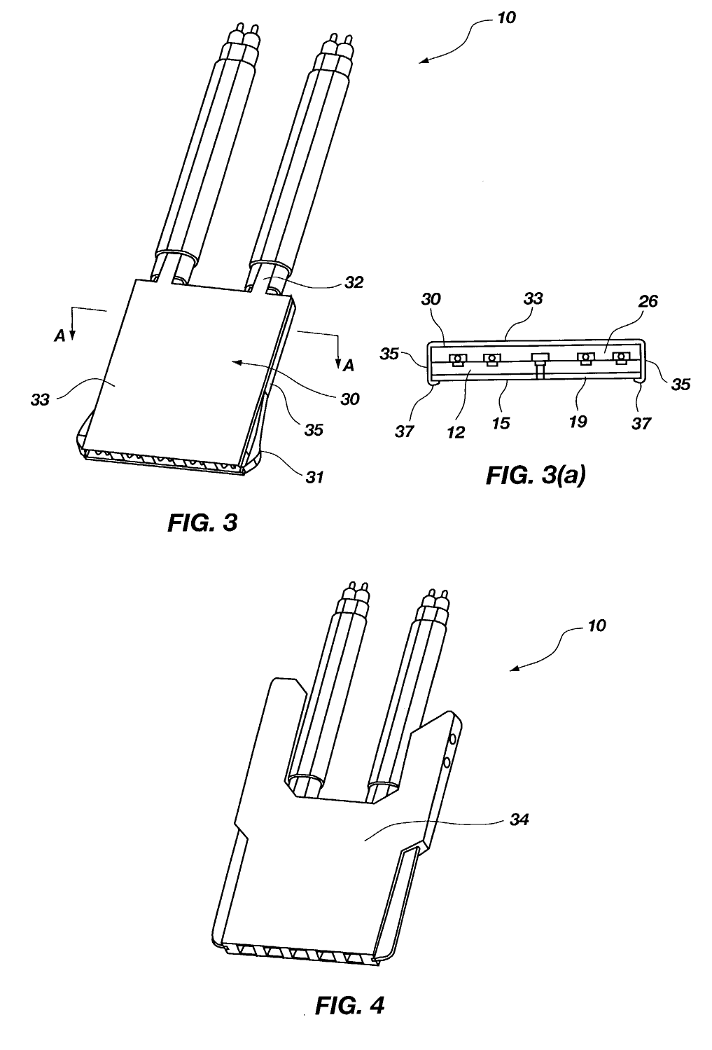

With respect to FIGS. 3 and 3(a), the electrical connector 10 receives a shield structure 30. The shield structure can include a C-shaped cross-section configured to be disposed over the core 26 and wrapped around to a peripheral side portion of the back side 15 of the PCB 12. More particularly, the shield structure 30 can include a substantially planar surface 33 with end portions 35 extending laterally from opposing ends of the planar surface 33. Such laterally extending end portions 35 are operable to be coupled to the shielding layer 19 on the back side 15 of the PCB 12 via a lip portion 37 or crimp portion. The shield structure 30 can be made from a stainless steel material or any other suitable electrically conductive material for shielding the conductive components in the electrical connector as known in the art. The end portions of the shield structure can be plated with nickel or an alloy thereof. The outside surface of the end portions can be additionally plated with gold or an alloy thereof. Such plating can be implemented by an electrolytic process or any other suitable process known in the art.

The shield structure 30 also can include a pair of connector crimps 32 and contact members 31. The connector crimps 32 can be operable to be wrapped around and bonded to a shielding portion on the cables 14 and 16 to provide grounding contact between the shield structure 30 and the cables 14 and 16. The inside surface of the connector crimps 32 can be nickel and/or gold plated or plated with a nickel and/or gold alloy to provide the bonding characteristics needed between the connector crimps 32 and the first and second cables 14 and 16. The contact members 31 can be stamped-out of the shield structure 30 to protrude laterally from the end portions 35 of the shield structure 30. Such contact members 31 can be operable with the electrical connector 10 to facilitate a ground contact for the electrical connector 10, and more specifically, with the center trace contact 24 (FIG. 1) on the PCB 12.

With this arrangement, the shield structure 30 having the contact members and connector crimps is a single piece structure facilitating multiple functions for the electrical connector. Further, the shield structure 30 acts in conjunction with the shield layer 19 formed on the PCB 12 to form the complete shielding package for the electrical connector 10. As such, the material required for forming the shield structure 30 is substantially reduced by approximately 40 percent as compared to typical shielding structures required to extend around the entire electrical connector 10. Such reduction in material is also advantageous in that space is saved in the thickness of the electrical connector 10 since the shielding structure 30 of the present invention need only extend slightly over the back side 15 of the PCB 12 for bonding to the shield layer 19. Such space saved can be utilized with, for example, the housing unit (not shown) described hereinbelow.

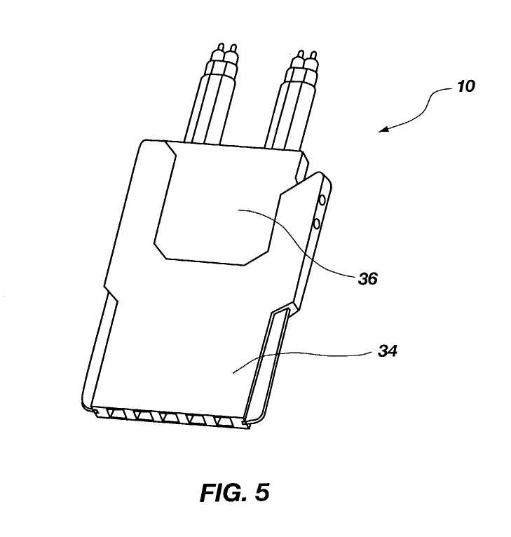

Referring now to FIG. 4, a housing unit 34 can be sized and configured to fit around the electrical connector 10, namely, the PCB 12-core 26-shield structure 30 assembly. The housing unit 34 can be sized and configured as a single member operable to slide over the electrical connector 10. Once the housing unit 34 receives the PCB 12-core 26-shield structure 30 assembly, the contact members 31 (FIG. 3) provide electrical contact within the housing 34 as well as provide a bias fit therein so that the contact members 31 are spring biased inward against the walls of the housing unit 34. The housing unit 34 can be formed from any suitable material, such as a polymeric type material. The housing unit 34 can also be configured such that multiple electrical connectors 10 can be stacked together and slid into slots within the housing unit 34 in a gained relationship. The housing unit 34 can be configured with one or more slots to receive, for example, one, two, four and/or six electrical connectors 10 or more depending on the industry standards or requirements.

Referring to FIG. 5, once the housing unit 34 is assembled to the electrical connector 10, an over-mold structure 36 can be formed to the electrical connector 10. The over-mold structure 36 is configured to protect the connection between the housing unit 34 and the first and second cables 14 and 16. As such, the over-mold structure 36 is formed around a portion of the housing unit 34 and a portion of the first and second cables 14 and 16 where such cables are coupled to the PCB 12. In this manner, the over-mold structure 36 provides a strain-relief for the electrical connector 10, and specifically, for the connection between the first and second cables and the PCB. The over-mold structure 36 can be formed by any suitable molding method known in the art, such as by injection molding.

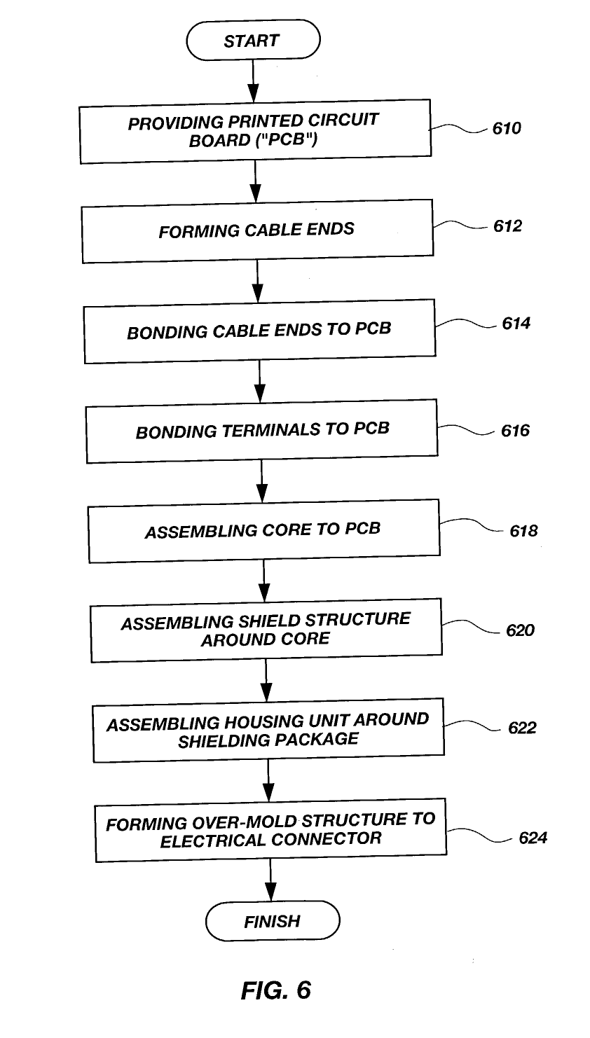

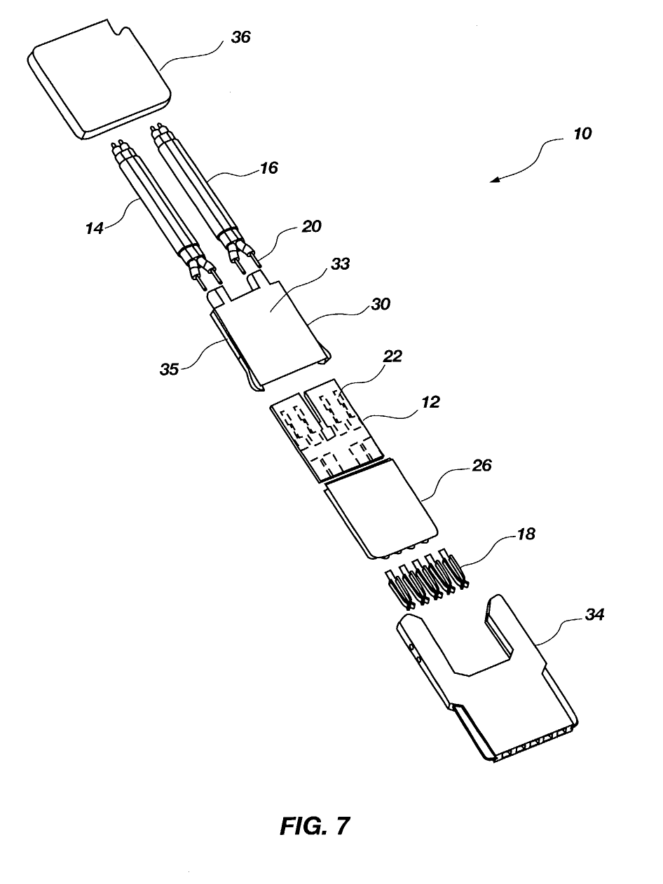

Turning now to FIG. 6, there is illustrated, in flow chart form, an embodiment by which the electrical connector 10 can be manufactured and assembled. With reference to both FIGS. 6 and 7, the PCB 12 is provided as indicated in block 610. Such a PCB 12 includes conductive traces 22 formed on the front side and a shielding layer 19 (FIG. 1(a)) formed on the back side of the PCB 12. The conductive traces 22 formed on the PCB 12 are sized and configured in a predetermined pattern so as to control the electrical characteristics and performance of the electrical connector 10.

As indicated in block 612, wire ends 20 of the first and second cable 14 and 16 are formed. In particular, the first and second cable 14 and 16 is measured, cut and stripped to expose the wire ends 20 at the end of the first and second cable 14 and 16. Such wire ends 20 can then be bonded to the conductive traces 22 on the PCB 12, as indicated in block 614. Such bonding can be implemented by any suitable method known to one of ordinary skill in the art, such as by soldering the wire ends 20 to the conductive traces 22. As indicated in block 616, the conductive terminals 18 can then be bonded to the conductive traces 22 on the PCB 12. Such conductive terminals 18 can also be bonded to the PCB 12 utilizing any suitable method, such as by soldering. It should be noted that the conductive terminals 18 can be bonded to the PCB 12 prior to bonding the wire ends 20 to the PCB 12 if desired.

As indicated in block 618, the core 26 can then be assembled over the front side of the PCB 12. As previously indicated, such core 26 is made from a dielectric material and serves to electrically insulate the conductive components on the PCB 12. Once the core 26 is positioned on the PCB 12, a shield structure 30 can then be positioned around the core 26 to wrap around to a peripheral side portion of the shield layer 19 on the back side of the PCB 12, as indicated in block 620. The shield structure 30 includes a planar surface 33 with end portions 35 extending laterally from opposing sides of the planar surface 33. The end portions 35 can be crimped around to contact the shield layer 19 on the back side of the PCB 12. Such end portions 35 can then be bonded to the peripheral side portions of the shield layer 19. In this manner, the shield structure 30 in conjunction with the shield layer 19 provides a complete shielding package for the electrical connector 10.

As indicated in block 622, the housing unit 34 can be assembled to the shielding package. The housing unit 34 can be assembled by sliding the shielding package within such housing unit 34. At this stage, an over-mold structure 36 can be formed to a portion of the housing unit 34 and first and second cables 14 and 16 for protecting and maintaining the electrical connection between the first and second cable 14 and 16 and the PCB 12, as indicated in block 624. Such over-mold structure can be formed by any suitable molding method as known to one of ordinary skill in the art, such as injection molding.

In the case where it is desired to form multiple electrical connectors 10 together in a stacked arrangement, such can be implemented prior to forming the over-mold structure 36. In this case, the electrical connectors 10 can be inserted into slots formed in the housing unit 34 in a stacked relationship. Once inserted, the stacked electrical connector arrangement can then receive the over-mold structure 36 as previously set forth.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A cable connector configured for high frequency signal transmission, the cable connector comprising:
a printed circuit board (“PCB”) having a first side with a plurality of conductive traces formed thereon, each trace having a first end and a second end, and a second side with a shield layer formed thereon;
at least one conductive cable with a plurality of conductive wires, one end of each wire being electrically connected to the first end of one of the plurality of conductive traces; and
a shield structure, mounted over the first side of the PCB to provide shielding and connected to a portion of said at least one conductive cable, said shield structure further including grounding contacts that are coupled to a portion of the first side of the PCB and to the shield layer.

2. The cable connector of claim 1, wherein said shield structure comprises a substantially C-shaped cross-section configured to be disposed over said first side of said PCB and wrap around to said second side of said PCB.

3. The cable connector of claim 1, wherein said shield structure comprises a substantially planar surface with end portions extending laterally from opposing ends of said planar surface and configured to interconnect with a portion of said shield layer.

4. The cable connector of claim 3, wherein said grounding contacts are integrated in said end portions of said shield structure.

5. The cable connector of claim 3, wherein said end portions comprise a lip member configured to extend and directly contact with a peripheral side portion of said shield layer.

6. The cable connector of claim 1, wherein said PCB comprises terminal contacts each with a first end and a second end, one end of each of said terminal contacts electrically interconnecting with said second end of one of said plurality of traces.

7. The cable connector of claim 6, further comprising a dielectric core with notches defined therein, said dielectric core operable to be disposed over said PCB so that said terminal contacts are disposed in said notches.

8. The cable connector of claim 7, wherein said dielectric core is configured to be disposed between said printed circuit board and said shield structure.

9. The cable connector of claim 8, further comprising an external housing unit configured to house each of said shield structure, said dielectric core and said printed circuit board.

10. The cable connector of claim 9, further comprising an overmolding structure configured to be disposed over at least a portion of said at least one conductive cable and said housing unit.

11. The cable connector of claim 1, wherein at least one of said plurality of traces is configured as a grounding member.

12. A method of making a cable connector configured for a high frequency signal transmission, the method comprising:
providing a printed circuit board (“PCB”) having a first side with a plurality of conductive traces formed thereon, each trace having a first end and a second end, and a second side with a shield layer formed thereon;
bonding the plurality of wires to the plurality of traces such that one wire is attached to the first end of one trace;
providing a shield structure having at least one grounding contact; and
securing the shield structure over the first side of the PCB and to a portion of the conductive cable such that the at least one grounding contact is coupled to a portion of the first side of the PCB and to the shield layer.

13. The method of claim 12, wherein said providing said shield structure comprises configuring said shield structure with a substantially C-shaped cross-section configured to be disposed over said first side of said PCB with ends wrapped around to said second side of said PCB.

14. The method of claim 12, wherein said providing said shield structure comprises configuring said shield structure with a substantially planar surface with end portions extending laterally from opposing ends of said planar surface and configured to interconnect with a portion of said shield layer.

15. The method of claim 14, wherein said configuring said shield structure comprises configuring said end portions of said shield structure to include said at least one grounding contact.

16. The method of claim 14, wherein said securing said shield structure comprises bonding an end of said end portions to a peripheral side portion of said shield layer.

17. The method of claim 12, further comprising providing terminal contacts and bonding said terminal contacts to said second end of said plurality of conductive traces on said PCB.

18. The method of claim 17, further comprising providing a dielectric core with notches defined therein.

19. The method of claim 18, further comprising disposing said dielectric core between said PCB and said shield structure with said terminal contacts disposed in said notches.

20. The method of claim 19, further comprising providing a housing unit configured to house each of said shield structure, said dielectric core and said PCB.

21. The method of claim 20, further comprising sliding each of said shield structure, said dielectric core and said PCB in said housing unit.

22. The method of claim 21, further comprising forming an over-mold structure configured to be disposed over at least a portion of said conductive cable and said housing unit.

23. The method of claim 12, wherein said providing said PCB comprises configuring at least one of said plurality of traces as a grounding member.

24. The method of claim 23, wherein said providing said shield structure comprises configuring said at least one grounding contact to be electrically interconnected to said grounding member.

25. A cable connector configured for high frequency signal transmission, the cable connector comprising:
a printed circuit board (“PCB”) having a first side with a plurality of conductive traces formed thereon, each trace having a first end and a second end, and a second side with a shield layer formed thereon;
at least one conductive cable with a plurality of conductive wires, one end of each wire being coupled to the first end of one of the plurality of conductive traces;
a plurality of terminal contacts each having a portion coupled to the second end of one of the plurality of conductive traces;
a dielectric core having notches defined therein and operable to be disposed over the first side of the PCB with the plurality of terminal contacts and the ends of the plurality of conductive wires disposed in the notches defined in the dielectric core; and
a shield structure having a substantially planar surface with end portions extending laterally from opposing ends of said planar surface, said shield structure operable to be disposed over said dielectric core with said end portions wrapped around to couple with a peripheral side portion of the shield layer so that said shield structure and said shield layer act in conjunction to provide a shielding package for said cable connector.
